(19) United States
(12) Patent Application Publication
(10) Pub. No.: US 2026/0168299 A1
(43) Pub. Date: Jun. 18, 2026

(54) Safety Door Lock

(71) Applicant: Hangzhou Weitaite Building Materials Co., Ltd., Hangzhou (CN)

(72) Inventor: Zaixin Zhang, Luzhou (CN)

(21) Appl. No.: 19/212,563

(22) Filed: May 19, 2025

(30) Foreign Application Priority Data
Dec. 16, 2024 (CN) 2024231059000

(51) Int. Cl. E05C 19/02

(52) U.S. Cl. CPC E05C 19/02

(57) ABSTRACT

A safety door lock includes a fixing plate, an adjustable plate and an elastic component. The fixing plate is provided with a through hole extending along its axial direction. The through hole is provided with a sealing plug at the bottom and two openings on a side wall. The openings are designed with a notch. The adjustable plate includes an adjustable ring arranged in the through hole, a connection piece and a protection component. One end of the connection piece is connected to the adjustable ring, and an other end of the connection piece extends to an outside of the through hole through the opening to be connected with the protection component. The elastic component includes a spring arranged between the active component and the sealing plug, and an active component which is inserted into the through hole. The active component is fixedly connected to the adjustable ring.

### CROSS-REFERENCE TO RELATED APPLICATIONS

The present application claims the benefit of Chinese Patent Application No. 2024231059000 filed on December 16, 2024, the contents of which are hereby incorporated by reference.

### Technical Field

The present invention belongs to the technical field of door locks and particularly relates to a safety door lock.

### Technical Background

In some remote areas or areas with poor public security, residents may encounter burglary. Thieves usually use lock picking tools to force their way into residents’ homes and steal residents’ property when the residents are not at home. Some extreme thieves may use violence to open the door even if they find the residents at home, which may threaten the residents’ personal safety.

Therefore, some residents will install additional safety locks in addition to the built-in door locks for their own personal safety and property safety. The common safety locks on the market are hinge-type designs, which rely on the user to manually move the door block to the front of the door to protect the door. However, this type of safety lock mainly relies on its own weight to lock. If the resident accidentally touches the door block when closing the door outside, the safety lock may be locked, making it impossible for the user to enter the room again, which brings a bad experience to the user.

Therefore, there is an urgent need to provide a safety door lock that can prevent accidental touches.

### Invention Content

In order to overcome the deficiencies of the prior art, the present invention provides a safety door lock. The safety door lock can prevent accidental touches, and the user should apply a certain external force on the safety door lock to lock the door.

The technical scheme adopted by the present invention for solving the technical problems is as follows:

A safety door lock includes a fixing plate, an adjustable plate and an elastic component. The fixing plate is provided with a through hole extending along its axial direction. A sealing plug is arranged at the bottom end of the through hole. Two openings are arranged at the side wall of the through hole, and the openings are respectively provided with at least one notch. The adjustable plate includes an adjustable ring, a connection piece and a protection component. The adjustable ring is arranged in the through hole. One end of the connection piece is connected to the adjustable ring, and the other end of the connection piece extends to the outside of the through hole through the opening to be connected with the protection component. The elastic component includes a spring and an active component. One end of the active component is inserted into the through hole along the end of the through hole away from the sealing plug, and the other end of the active component overlaps the outer edge of the through hole. The spring, in a compressed state, is arranged between the active component and the sealing plug. The adjustable ring is fixedly connected to the outer periphery of the active component.

Further, a first screw thread is arranged on the outer periphery of the active component. A second screw thread is arranged on the inner periphery of the adjustable ring. The first screw thread is matched with the second screw thread. The adjustable ring and the active component are fixedly connected through the screw threads.

Further, the sealing plug is set as a cylindrical structure, which is closed at one end and with an opening hole at the other end; the spring is arranged inside the sealing plug; the active component is inserted into the interior of the sealing plug along the opening hole to compress the spring.

Further, a third screw thread is arranged on the outer periphery of the sealing plug. A fourth screw thread is arranged on the inner wall of the through hole. The third screw thread is matched with the fourth screw thread. The sealing plug and the through hole are fixedly connected through screw threads.

Further, the through hole is provided with two openings on a side wall, and each of the openings is provided with two notches. The two adjustable rings and the two connection pieces are arranged on the adjustable plate.

Further, a plurality of mounting holes is arranged on the fixing plate.

Further, the fixing plate includes a first fixing component and a second fixing component. The plurality of mounting holes is arranged on the second fixing component. The second fixing component and the first fixing component are integrally formed. The through hole is arranged on the first fixing component.

Further, each of the two openings is provided with a first notch and a second notch. The first notch is arranged on a side of the first fixing component close to the second fixing component. The second notch is arranged on a side of the first fixing component away from the second fixing component.

Further, the adjustable ring, the connection piece and the protection component are integrally formed.

Further, the protection component includes a first protection component and a second protection component. The first protection component is perpendicularly connected to the connection component.

The beneficial effects of the present invention:

The present invention provides a safety door lock. The safety door lock is provided with an elastic component and an adjustable plate. When the adjustable plate is unlocked, the elastic component will abut against the fixing plate. The user needs to apply a certain external force to rotate and lock the door, which can prevent accidental touch and improve the user’s experience.

### DESCRIPTION OF FIGURES

FIG. 1 is a schematic view of a safety door lock in a locked state of the present invention;

FIG. 2 is a schematic view of the safety door lock in an unlocked state of the present invention;

FIG. 3 is a schematic view of the safety door lock in an unlocked state from another angle of the present invention;

FIG. 4 is a cross-sectional view along line A-A in FIG. 3;

FIG. 5 is an exploded view of the safety door lock of the present invention;

FIG. 6 is a schematic view of a fixing plate of the safety door lock of the present invention;

FIG. 7 is a schematic view of the safety door lock and door frame in a locked state of the present invention;

FIG. 8 is a schematic view of the safety door lock and door frame in an unlocked state of the present invention;

### Description of marks in figures:

1- fixing plate; 11- through hole; 12- sealing plug; 121- third screw thread; 122- opening hole; 13- fourth screw thread; 14- opening; 15- notch; 151- first notch; 152- second notch; 16- first fixing component; 17- second fixing component; 171- mounting hole; 2- adjustable plate; 21- adjustable ring; 211- second screw thread; 22- connection piece; 23- protection component; 231- first protection component; 232- second protection component; 233- convex piece; 3- elastic component; 31- spring; 32- active component; 321- first screw thread; 4- door frame; 5- wall.

### DETAILED DESCRIPTION OF THE EMBODIMENTS

The following will clearly and completely describe the concept, specific structure and technical effects of the present invention in combination with the embodiments and drawings, so as to fully understand the purpose, characteristics and effects of the present invention. Obviously, the embodiments described are only part of the embodiments of the present invention, not all of them. Based on the embodiments of the present invention, other embodiments obtained by technicians in this field without creative work are all within the scope of protection of the present invention. In addition, all the linkage or connection relationships involved in the patent do not merely refer to the direct connection of components but refer to the formation of a better linkage structure by adding or reducing linkage accessories according to the specific implementation situation. The various technical features in the creation of the present invention can be combined interchangeably without conflicting with each other.

The present invention provides a safety door lock. The safety door lock is provided with an elastic component and an adjustable plate. When the adjustable plate is unlocked, the elastic component will abut against the fixing plate. The user needs to apply a certain external force to rotate and lock the door, which can prevent accidental touch and improve the user’s experience.

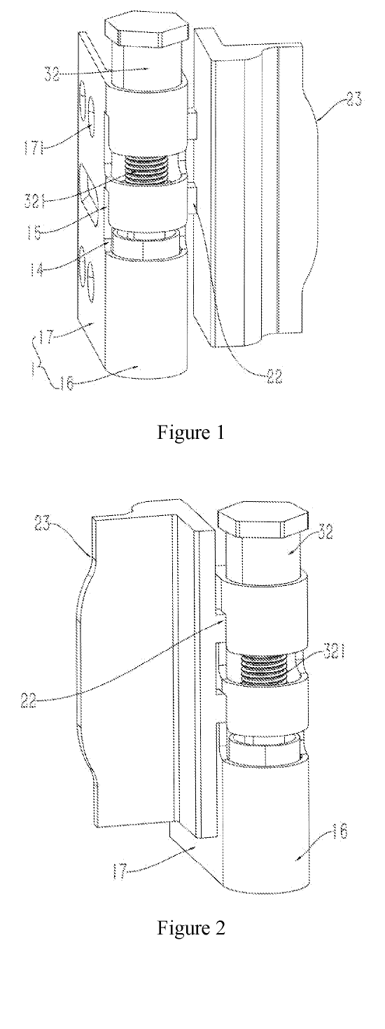

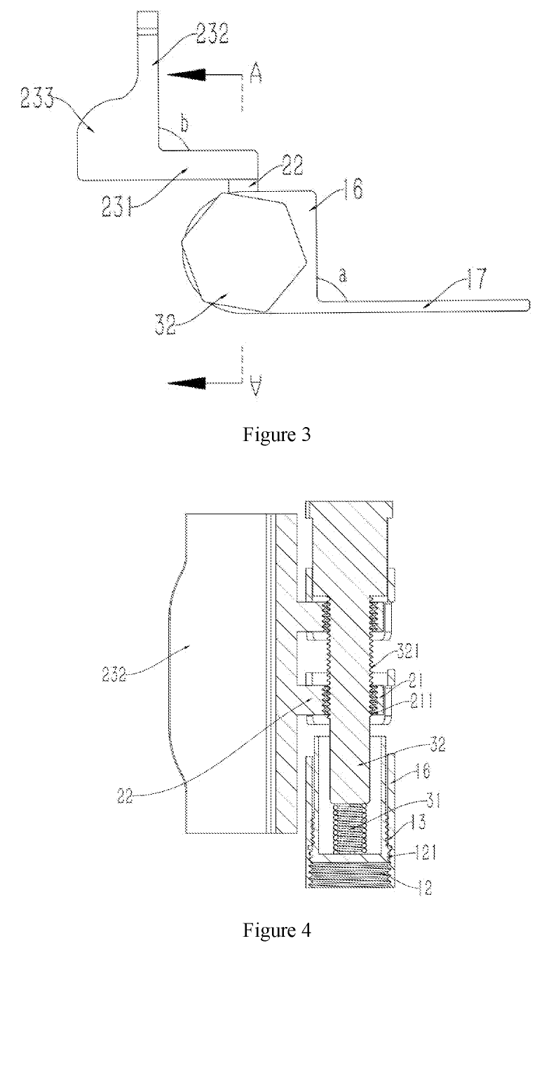

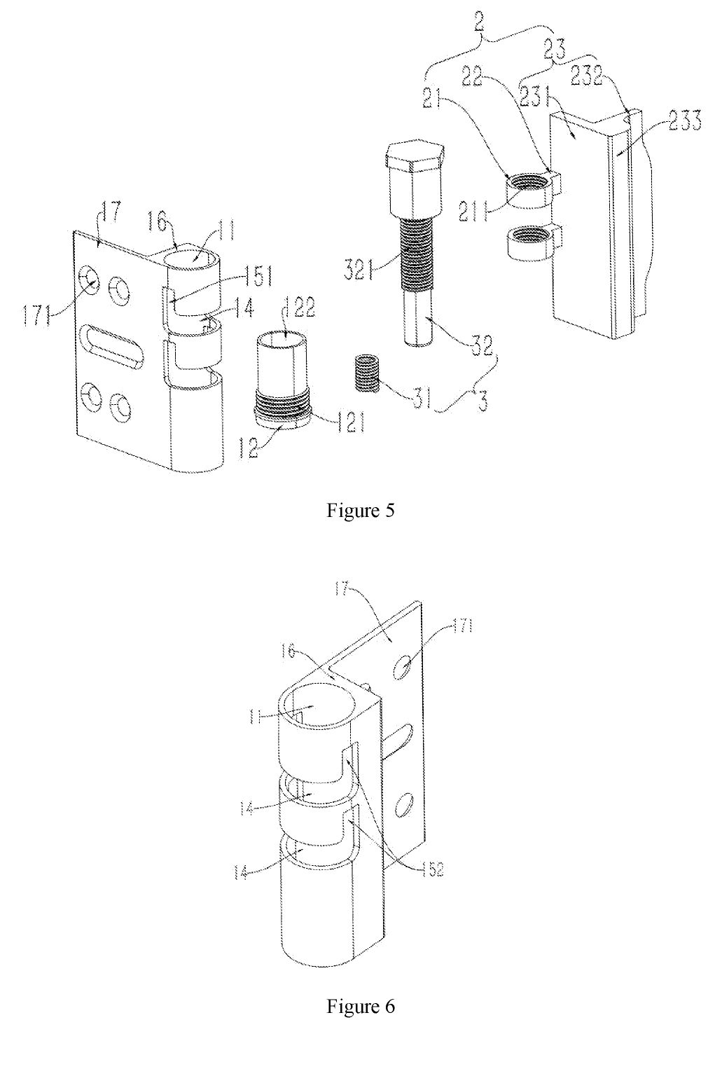

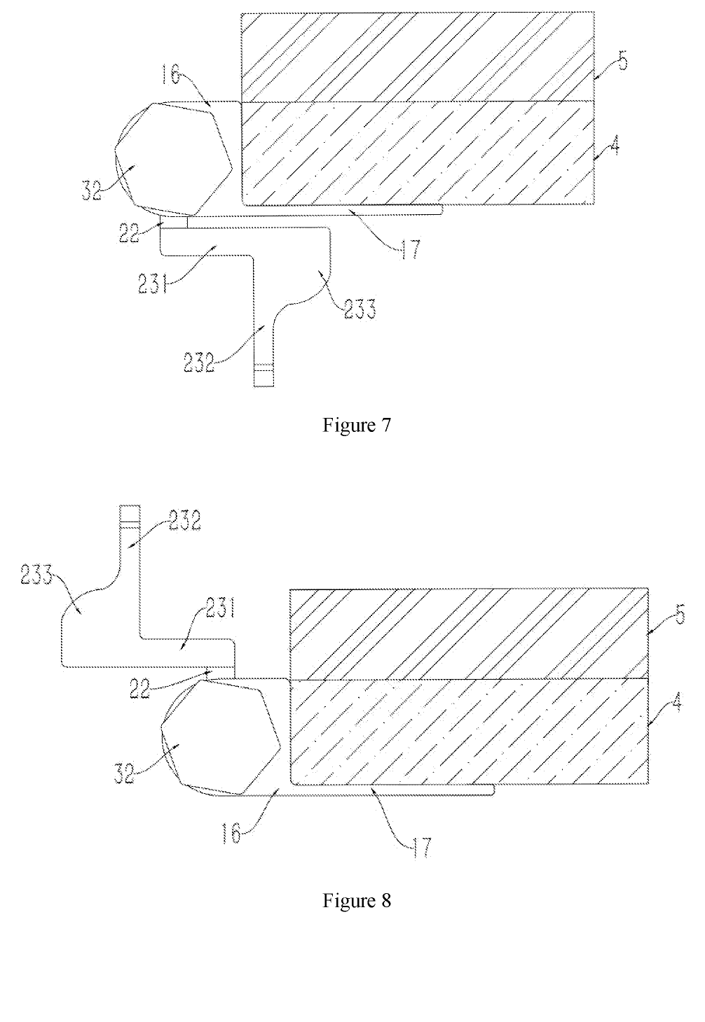

Referring to FIGS. 1 to 8, this embodiment provides a safety door lock, including a fixing plate 1, an adjustable plate 2, and an elastic component 3.

The fixing plate 1 is provided with a through hole 11 extending along its axial direction. A sealing plug 12 is arranged at the bottom end of the through hole 11. Two openings 14 are arranged at the side wall of the through hole 11. The openings 14 are respectively provided with at least one notch 15.

The adjustable plate 2 includes an adjustable ring 21, a connection piece 22 and a protection component 23. The adjustable ring 21 is arranged in the through hole 11. One end of the connection piece 22 is connected to the adjustable ring 21, and the other end of the connection piece 22 extends to the outside of the through hole 11 through the opening 14 to be connected with the protection component 23.

The elastic component 3 includes a spring 31 and an active component 32. One end of the active component 32 is inserted into the through hole 11 along the top end of the through hole 11, and the other end of the active component 32 overlaps on the outer edge of the through hole 11. The spring 31, in a compressed state, is arranged between the active component 32 and the sealing plug 12.

The adjustable ring 21 is fixedly connected to the outer periphery of the active component 32. Specifically, a first screw thread 321 is arranged on the outer periphery of the active component 32, and a second screw thread 211 is arranged on the inner periphery of the adjustable ring 21. The first screw thread 321 is matched with the second screw thread 211, so that the active component 32 and the adjustable ring 21 are in a linkage relationship.

Understandably, the spring 31 has a limited service life. After frequent use, the spring 31 will lose its elasticity and cannot provide effective driving force for the movement of the active component 32, resulting in the failure to lock the safety door lock in this embodiment; or the active component 32 is stuck, resulting in the inability to unlock the safety door lock. The active component 32 and the adjustable plate 2 are detachably connected through screw threads. In this way, the user can unscrew the active component 32 from the upper screw thread of the through hole 11 to remove the active component 32, so as to replace the spring 31 inside the through hole 11, thereby ensuring the normal use of the safety door lock.

Under the action of external force, the connection piece 22 can rotate along the opening 14. The adjustable ring 21 and the active component 32 are in a linkage relationship, and the spring 31 is in a compressed state. It means that the spring 31 has an elastic restoring force, which can provide a force for the active component 32 to move upward.

When the adjustable ring 21 rotates in the portion of the opening 14 where the notch 15 is not provided, the restoring force provided by the spring 31 will cause the connection piece 22 to abut against a top wall of the opening 14, and the active component 32 is restricted and cannot move upward. At this time, the safety door lock of this embodiment is in an unlocked state.

When the connection piece 22 rotates to face the notch 15, the restoring force provided by the spring 31 will push the active component 32 to move upward. And the restoring force will drive the connection piece 22 to slide into the notch 15 and abut against a top wall of the notch 15 at the same time. At this time, the safety door lock of this embodiment is in a locked state. When it needs to be unlocked again, the user needs to apply a certain force to the adjustable plate 2, so that the connection piece 22 of the adjustable plate 2 moves downward to the opening 14 and rotates along the opening 14 until the connection piece 22 is staggered with the notch 15.

Understandably, by providing the elastic component 3, when locking is not required, the adjustable plate 2 will be abutted against the fixing plate 1 by the elastic component 3. The user needs to apply a certain external force to rotate and lock the door lock, so the accidental touch an be prevented. Therefore, the technical problems in the prior art that locking the door lock by accidental touch, causing inconvenience to the user can be solved.

Preferably, the sealing plug 12 is set as a cylindrical structure, which is closed at one end and with an opening hole 122 at the other end. The spring 31 is arranged inside the sealing plug 12. The active component 32 is inserted into the interior of the sealing plug 12 along the opening hole 122 to compress the spring 31. By setting the sealing plug 12 as a cylindrical structure, an inner wall of the sealing plug 12 can be used to guide the moving direction of the spring 31, so that the active component 32 can compress the spring 31, or the spring 31 can push the active component 32 to move upward.

Correspondingly, the cylindrical structure of the sealing plug 12 can also guide the moving direction of the active component 32, so that the active component 32 can move in the vertical direction.

Preferably, a third screw thread 121 is arranged on the outer periphery of the sealing plug 12. A fourth screw thread 13 is arranged on the inner wall of the through hole 11. The third screw thread 121 is matched with the fourth screw thread 13 to achieve a detachable connection of the sealing plug 12 and the through hole 11.

In combination with the above, as the sealing plug 12 is detachable connected with the fixing plate 1 through screw threads, the user can unscrew the sealing plug 12 from the fixing plate 1 and remove the sealing plug 12 to replace the spring 31 inside the through hole 11, so as to ensure the normal use of the safety door lock.

Preferably, the through hole 11 is provided with two openings 14 on a side wall, and each of the openings 14 is provided with two notches 15. Two adjustable rings 21 and two connection pieces 22 are arranged on the adjustable plate 2. The two adjustable rings 21 correspond to the two openings 14 one by one. The two connection pieces 22 can be inserted into the two notches 15 respectively.

Preferably, a plurality of mounting holes 171 are arranged on the fixing plate 1. As can be seen from the accompanying drawings, the plurality of mounting holes 171 include round holes and waist-shaped holes. The plurality of mounting holes can be matched with different locking components to fix the fixing plate 1 on the door frame 4.

Preferably, the fixing plate 1 includes a first fixing component 16 and a second fixing component 17. The plurality of mounting holes 171 are arranged on the second fixing component 17. The second fixing component 17 and the first fixing component 16 are integrally formed. The through hole 11 is arranged on the first fixing component 16.

Preferably, the first fixing component 16 is arranged to protrude from a surface of the second fixing component 17. The angle a between the first fixing component 16 and the second fixing component 17 is 90 degrees. It can be understood that when the safety door lock provided in this embodiment is fixed to the door frame 4 for use, the second fixing component 17 is fixedly connected to a side of the door frame 4. The angle formed by the first fixing component 16 and the second fixing component 17 can be closely fitted with an edge of the door frame 4, which can save the installation space of the safety door lock.

Preferably, each of the two openings 14 is provided with a first notch 151 and a second notch 152. The first notch 151 is arranged on the side of the first fixing component 16 close to the second fixing component 17, and the second notch 152 is arranged on the side of the first fixing component 16 away from the second fixing component 17. When the safety door lock in this embodiment is installed on the door, the first fixing component 16 and the second fixing component 17 overlap on the side and the edge of the door frame 4. When the user turns the adjustable plate 2 to rotate until the connection piece 22 slides into the first notch 151 under the action of the elastic component 3, the safety door lock in this embodiment is locked to provide a protective effect. When the user needs to enter or exit the door, the user can move the adjustable plate 2 downward to make it leave the first notch 151, and rotate the connection piece 22 in the opening 14 until the connection piece 22 slides into the second notch 152 under the action of the elastic component 3, the safety door lock in this embodiment is unlocked, and the user can freely open the door to enter or exit.

Understandably, if only the side of the first fixing component 16 close to the second fixing component 17 is provided with the first notch 151, the adjustable plate 2 can also move in the notch 15 and the opening 14 under the action of external force to achieve the locking and unlocking functions. However, this design has defects. For example, when the adjustable plate 2 is moved to the opening 14, the user’s limbs can easily hit the adjustable plate 2 during the process of entering or exiting, which poses a safety hazard. If the impact force is large, the adjustable plate 2 may be moved to a locked state, affecting the user’s use. However, the second notch 152 is arranged on the side of the first fixing component 16 away from the second fixing component 17. In this way, when the user enters or exits, the adjustable plate 2 can be moved to the second notch 152 on the side of the door frame 4 away from the door panel to get stuck, thereby avoiding limbs from hitting the adjustable plate 2 and reducing safety hazards.

Preferably, the adjustable ring 21, the connection piece 22 and the protection component 23 are integrally formed. Since the adjustable plate 2 is integrally formed, there are no redundant connection points on it. Therefore, the safety door lock can provide strong protection and reduce the occurrence of violent intrusions into the room.

Further, the protection component 23 includes a first protection component 231 and a second protection component 232. The first protection component 231 is perpendicularly connected to the connection piece 22. The second protection component 232 is connected to one end of the first protection component 231 away from the connection piece 22. The angle b between the second protection component 232 and the first protection component 231 is 90 degrees. When the connection piece 22 moves into the first notch 151, the safety door lock is locked. At this time, the first protection component 231 is parallel to the second fixing component 17, and the second protection component 232 is parallel to the wall 5, which can provide better protection and prevent the user from hitting the protection component 23.

Further, the second protection component 232 is provided with a convex piece 233, and the convex piece 233 is arranged on a side of the second protection component 232 away from the first protection component 231. The convex piece 233 is connected to a surface of the second protection component 232 through a rounded corner. The convex piece 233 is provided to enhance the anti-collision capability of the protection component 23.

It is understandable that those skilled in the art can combine various implementations in the above embodiments under the guidance of the above embodiments to obtain technical solutions of multiple implementations.

The above description is only a preferred embodiment of the present invention and is not intended to limit the present invention. Any modifications, equivalent replacements and improvements made within the spirit and principles of the present invention shall be included in the protection scope of the present invention.

1. A safety door lock comprises a fixing plate, an adjustable plate and an elastic component, wherein the fixing plate is provided with a through hole extending along its axial direction; a sealing plug is arranged at a bottom end of the through hole; two openings are arranged at a side wall of the through hole; the openings are respectively provided with at least one notch;
wherein the adjustable plate comprises an adjustable ring, a connection piece and a protection component; the adjustable ring is arranged in the through hole; one end of the connection piece is connected to the adjustable ring, and an other end of the connection piece extends to an outside of the through hole through the opening to be connected with the protection component;
wherein the elastic component comprises a spring and an active component; one end of the active component is inserted into the through hole along one end of the through hole away from the sealing plug, and another end of the active component overlaps an outer edge of the through hole; the spring, in a compressed state, is arranged between the active component and the sealing plug; the adjustable ring is fixedly connected to an outer periphery of the active component.

2. The safety door lock according to claim 1, wherein a first screw thread is arranged on the outer periphery of the active component; a second screw thread is arranged on an inner periphery of the adjustable ring; the first screw thread is matched with the second screw thread; the adjustable ring and the active component are fixedly connected through screw threads.

3. The safety door lock according to claim 1, wherein the sealing plug is set as a cylindrical structure, which is closed at one end and with an opening hole at another end; the spring is arranged inside the sealing plug; the active component is inserted into an interior of the sealing plug along the opening hole to compress the spring.

4. The safety door lock according to claim 1, wherein a third screw thread is arranged on an outer periphery of the sealing plug; a fourth screw thread is arranged on an inner wall of the through hole; the third screw thread is matched with the fourth screw thread; the sealing plug and the through hole are fixedly connected through screw threads.

5. The safety door lock according to claim 1, wherein the through hole is provided with two openings on a side wall, wherein each of the openings is provided with two notches; two adjustable rings and two connection pieces are arranged on the adjustable plate.

6. The safety door lock according to claim 1, wherein a plurality of mounting holes is arranged on the fixing plate.

7. The safety door lock according to claim 6, wherein the fixing plate comprises a first fixing component and a second fixing component; the plurality of mounting holes is arranged on the second fixing component; the second fixing component and the first fixing component are integrally formed; the through hole is arranged on the first fixing component.

8. The safety door lock, according to claim 6, wherein each of the two openings is provided with a first notch and a second notch; the first notch is arranged on a side of the first fixing component close to the second fixing component; the second notch is arranged on a side of the first fixing component away from the second fixing component.

9. The safety door lock according to claim 1, wherein the adjustable ring, the connection piece and the protection component are integrally formed.

10. The safety door lock according to claim 1, wherein the protection component comprises a first protection component and a second protection component; the first protection component is perpendicularly connected to the connection piece.
